(19) United States
(12) Patent Application Publication
(10) Pub. No.: US 2016/0055560 A1
(43) Pub. Date: Feb. 25, 2016

(54) SYSTEM FOR FACILITATING POINT OF SALE TRANSACTIONS

(71) Applicant: TOFUGEAR LIMITED, Kowloon (CN)

(72) Inventor: JOHN DARRELL McKELVEY, Keyser, WV (US)

(73) Assignee: TOFUGEAR LIMITED, Kowloon (CN)

(21) Appl. No.: 14/465,959

(22) Filed: Aug. 22, 2014

(51) Int. Cl. G06Q 30/06; G06Q 10/08; H04W 4/00

(52) U.S. Cl. CPC G06Q 30/0623; H04W 4/008; G06Q 10/087

(57) ABSTRACT

A system for providing products to a customer including stand-alone (micro store booth) containing products each having a passive RFID tag and a unique QR code affixed thereto adapted to be positioned within a retail establishment. The micro store booth includes a plurality of antennas for emitting a signal to activate the RFID tag and a RFID reader to obtain information unique to each product for storage on a storage medium. The product information is accessible by the customer through a Bluetooth low energy capable mobile device with a micro store booth app thereon to enable the customer to purchase the product.

### FIELD OF THE INVENTION

This invention relates generally to the merchandising of products in a retail establishment and more specifically to a system for facilitating consumer purchases through a sophisticated in-store stand-alone booth utilizing RFID and other technologies to allow consumers to interact with product offerings within the booth.

### BACKGROUND OF THE INVENTION

Various systems and methods are well known in the art to provide point of sale merchandizing transactions and e-commerce transactions. Typically in the point of sale transactions a customer interacts with retail store personnel to accomplish payment for the merchandise that is being purchased and as a result must typically wait in line with other customers thereby wasting an inordinate amount of time. In typical e-commerce transactions a customer typically through a website has an opportunity to view photographs or other representations and descriptions of products and then will add those products to a cart and check out by utilizing various payment methods well known to those in the art. Under these circumstances the consumer has no opportunity to interact with the merchandise which often results in the necessity to return the merchandise once it is received by a consumer.

There is thus a need in the merchandizing industry for a system which will permit interaction by a consumer with products that are available for sale with the consumer having detailed information with regard to the products followed by the ability to purchase the products on site through an online payment system thus eliminating unwelcomed sales personnel intervention.

### SUMMARY OF THE INVENTION

In one embodiment a system designed to be positioned within a retail establishment for providing access by consumers to products contained therein each having a passive RFID tag and a unique QR Code affixed thereto. The system includes a stand-alone structure capable of receiving the products. A plurality of antennas configured to emit electro magnetic wave signals to activate the RFID tags, a server, a RFID reader configured to emit electro magnetic wave interrogator signals to the RFID tags and receive replies from the RFID tags coupled to the server to provide inventory information related to the products, Bluetooth low energy capable device coupled to the server, a remote backend system including a digital storage medium, means wirelessly coupling the server to the remote backend system for transferring the inventory information to the backend system and a Bluetooth low energy capable mobile device configured to communicate with the remote backend system and the Bluetooth low energy capable device coupled to the server to provide real-time product and inventory information to the consumer and to permit the consumer to purchase product.

In an alternative embodiment the system includes a stand-alone structure capable of receiving the products, a plurality of antennas configured to emit electro magnetic wave signals to activate the RFID tags, a server, a RFID reader configured to emit electromagnetic wave interrogator signals to the RFID tags and receive replies from the RFID tags coupled to the server to provide inventory information related to the products, a remote backend system including a digital storage medium, means coupling the server to the remote backend system for transferring the inventory information to the backend system, a mobile device capable to read the QR code on the products to provide product information to the consumer.

### BRIEF DESCRIPTION OF THE DRAWINGS

FIG. 1 is a perspective view of a stand-alone system constructed in accordance with the principles of the present invention;

FIG. 2 is a block diagram showing the various components contained within the device of FIG. 1;

FIG. 3 is a block diagram indicating the manner in which goods are configured for use within the system of the present invention;

FIG. 4 is a block diagram illustrating the production of the goods to be contained within the system of the present invention;

FIG. 5 is a block diagram illustrating the interaction of a customer with the system of the present invention;

FIG. 6 is a flow chart illustrative of the manner in which a customer initiates interactivity with the system of the present invention; and

FIG. 7 is a flow chart illustrative of the manner in which a customer purchases product available in accordance with the principles of the present invention.

### DETAILED DESCRIPTION OF THE INVENTION

The term “micro store booth” is used throughout the specification to indicate a stand-alone structure which is positioned within a retail establishment and within which products for sale to consumers are housed. The stand-alone structure incorporates RFID technology which functions to provide inventory information about the products contained within a micro store booth which information can be accessed by a customer having a mobile device or alternatively through the utilization of a touch screen device such as a tablet that is incorporated into the micro store booth.

The invention is far reaching in scope, functioning from a consumer's perspective as an in-store solution for customers to interact with products in both a digital and real-world experience and provides the ability to touch, feel, try on, etc. product all the while able to review product information and handle the transaction from a designated touch screen device or their own mobile device. This greatly cuts down on conversion time (i.e. waiting at counter queues to transact purchases), and boosts consumer's confidence of purchase with the implied benefit of lower return rates as compared to buying products online from e-commerce alternatives.

From the retailers' and wholesalers' perspective, there are immense benefits for the utilization of the micro store booth. Since inventory is real-time managed and this information uploaded into a backend system, wholesalers electing to utilize the micro store booth can have a means of confidently tracking their products in retail stores, opening up opportunities for consignment of inventory, in return for product sales commission payments to retail shop owners for utilization of their floor space. In addition, there exists a serious problem for brick and mortar retail stores in most markets with the owners' ability to secure proper credit facilities for acquiring inventory. With ever-increasing real estate and rent prices in most global markets, the ability to consign inventory in return for a commission to the global markets, the ability to consign inventory in return for a commission to the retail store is a very unique opportunity that comes along with the invention of the micro store booth. At the very least, this opens a new opportunity at a very large scale for a tradeoff between wholesales and retailers to get their mutual goal of conversion achieved.

For retailers electing to own inventory maintained in the micro store booth, this real-time information and customer interaction analytics as provided by the booth's backend system can offer a unique solution to their own inventory management and fulfillment/procurement processes. By tracking inventory in the micro store booth, as well as better understanding consumer analytics and buying behaviors in a unique way from the micro store booth individual location, or at a store, regional, national and even international level, retailers will be more in control of their buying and selling velocities, with significant improvements to their overall product offerings and just in time placement on the booths' shelves.

With this level of accurate real-time inventory management, external systems can be connected with the micro store booth to allow inventory to be auto fulfilled, allocated and/or even shipped from overseas or a remote location based on integration with the micro store booth backend system. As mentioned above, this contributes to a just in time realization of inventory at store level that the current global markets are trending towards the rule, not the exception.

Further to the above-mentioned benefits of significant improvements with the efficiencies of space use, inventory management, and overall fulfillment procurement processes, providing retail stores with real-time inventory and sales analytics via the micro store booth backend system will allow retail stores and wholesalers alike to more effectively and efficiently adjust their inventory shipment velocities and consolidate and manage their factory to DC to store distribution. This offers a significant opportunity for carbon footprint reduction within the scope of local trucking up through overseas consolidation and shipment as some of its furthest reaching benefits.

The products will be tagged with RFID-enabled uniquely identified passive tags as well as uniquely identified printed QR barcodes on the product tags to specifically identify products being displayed in the micro store booths. By utilizing RF technology, each of the micro store booths will be able to recognize product loaded into the booth, and make said product available for sale via the integrated touch screen device or a mobile device app or similar web program. The printing of the unique QR barcode is necessary for mobile devices unable to use Bluetooth technology or to read RFID tags to be able to indicate product selected for purchase either within the booth or for later shipment. Without the unique QR code, there would be no way for mobile devices without RFID or Bluetooth technology to be able to interact with the micro store or purchase items, as a medium for product selection is necessary in this case.

For devices capable of utilizing Bluetooth or other similar technology for communicating between devices, the integration of Bluetooth low energy sensors within the micro store backend system will allow users from their mobile or web-based devices to access information about the booth-specific product offerings. This location software will also allow the backend system to determine customer location in store and at the micro store booth, and cater offerings, discounts and other services based on their in-store location.

In summary, the micro store booth platform has two main channels:

First, third party micro store booth—retail infrastructure owned or maintained by an unrelated host party are set up with consignment systems. Micro store booths in store retail units are assembled at each retail host location. Each unit comes equipped with inventory, optional hidden back stock inventory, reader systems and optional video monitor display units. The composite unit is owned by the third party wholesaler/vendor/etc. but the micro store booth is maintained by the host retailer.

The micro store booth is outfitted with sensors that monitor and track each stock item using the micro store in booth system. Monitoring takes place in a remote central location anywhere in the world using wired, internet, GSM, other cellular, Wi-Fi, and/or hotspot technology. The purchase transaction utilizes an integrated POS device which resides in the micro store booth network. The payment is processed into micro store systems which stats funds of the retail transaction. Within 24 hours, the consignment commission portion of the sales is transmitted back to the host retail merchant bank account. The major benefit to the host retailer is cost inventory burden has been removed. This is a benefit particularly to smaller independent specialty stores and boutiques who do not have the credit facilities to maximize their potential.

Additional option of consumer customization and direct home delivery can be added to the service. Consumers have an option to use the micro store booth as a physical experience but have the benefit of e-commerce processing to either gift or customize products. Using the customer's mobile device or the touch screen device mounted into the micro store booth, consumers can initiate customization of their product such as changing the inseam length of a pant, monogram a shirt, etc. In addition, gifting can be processed whereby the consumer chooses the purchase, enters the address into the micro store booth monitor, then transacts the purchase which will be delivered direct to the designated location. In addition, a fashion expert in the micro store brand can be immediately contacted by using the touch screen device or with camera and microphone equipment at the micro store booth should product questions or consultation be needed.

The micro store booth has additional advantages over traditional brick and mortar stores in maintaining on hand inventories in host store locations. The micro store booth backend system maintains a four channel approach to ensure inventory is never out of stock. Consumer conversion cannot take place without access, convenience and a satisfactory experience. Because each sku item is tagged with an RFID tag and tracked in real time, stock in the micro store location (or back stock at the host location) is monitored at all times. Should sku counts fall below acceptable matrix ratios, immediate inventory is dispatched to the host location.

Micro store booths also have a major advantage over traditional e-commerce sites. Because e-commerce sites have no ability to give a sensory experience to the consumer, conversion rates are low in items that require touch or fit to make an informed consumer purchase experience. With micro store booth access and immediate scale, the consumer can build a product relationship by touching and fitting the item before purchasing on line. More importantly, consumers have the ability to exchange the item should a previously purchased micro store booth item that was shipped directly to the consumer at any location participating in this program. Returns can take place at any micro store booth location regardless of brand being displayed. This is done utilizing the host retail staff to scan the item back into the micro store booth backend inventory system which triggers a credit back on the consumer credit card account (with participating vendors), stored value card (with participating retailers), or digital wallet account.

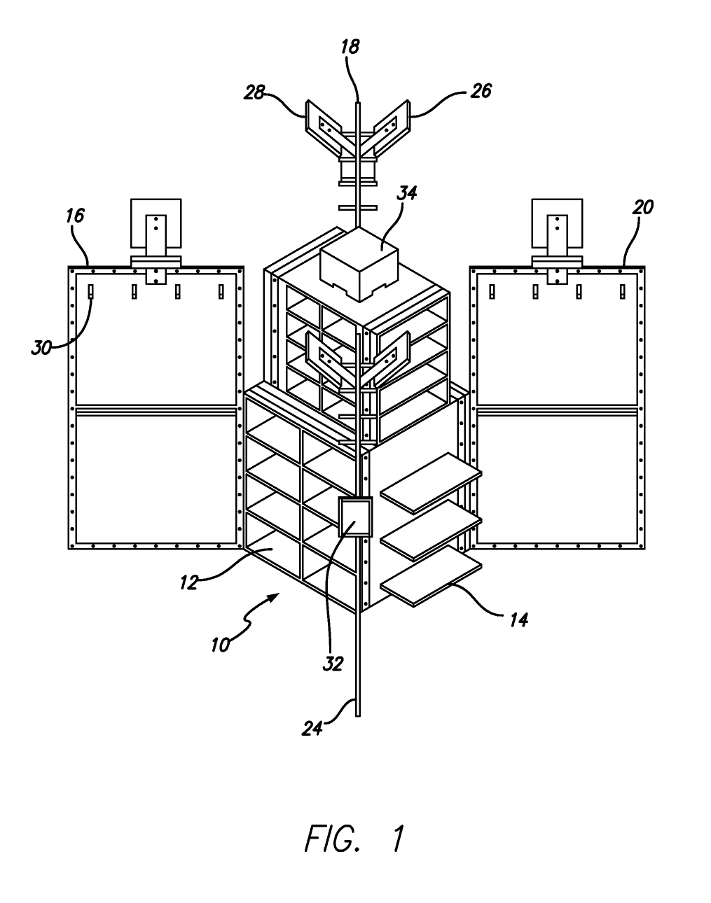

Referring now more particularly to FIG. 1, there is illustrated in perspective a stand-alone unit which is adapted to be positioned within a retail establishment and on which products for sale to customers may be housed. As is illustrated, there is a center tower 10 which has a plurality of shelf-like areas 12 within which products may be positioned. There are also exteriorly extending shelves 14 which will serve the same purpose with products being able to be placed thereon. There are four panels 16, 18, 20 and 24 which are attached to each corner of the central tower. Each of the panels has affixed to the top thereof a pair of antennas such as illustrated at 26 and 28 for the panel 18. It should be understood that the plurality of antennas may be secured to the panels in a different manner than that illustrated in FIG. 1. A plurality of pins such as illustrated at 30 protrude from each of the panels 16 through 24. Products, such as clothing, for one example, may be supported from the pins 30 and would extend downwardly along the side of each of the panels. A touch screen device such as a tablet 32 is affixed to the edge of the panel 24 and a similar touch screen device would also be affixed to the edge of each of the panels 16, 18 and 20. A controller 34 is situated atop the center tower and houses the control system which will be described in greater detail below. Situated within the controller would be an appropriate server with a central processing unit that is programed to provide appropriate electrical energy to activate the antennas such as those shown at 26 and 28. When the antennas are so activated, they will transmit a signal to activate the passive RFID tags which are affixed to each of the products that are contained within the stand-alone unit as shown in FIG. 1. When such is done, the information contained on the RFID tags which is unique to each of the products contained within the central tower or on the panels is read by an RFID reader housed within the control unit 34.

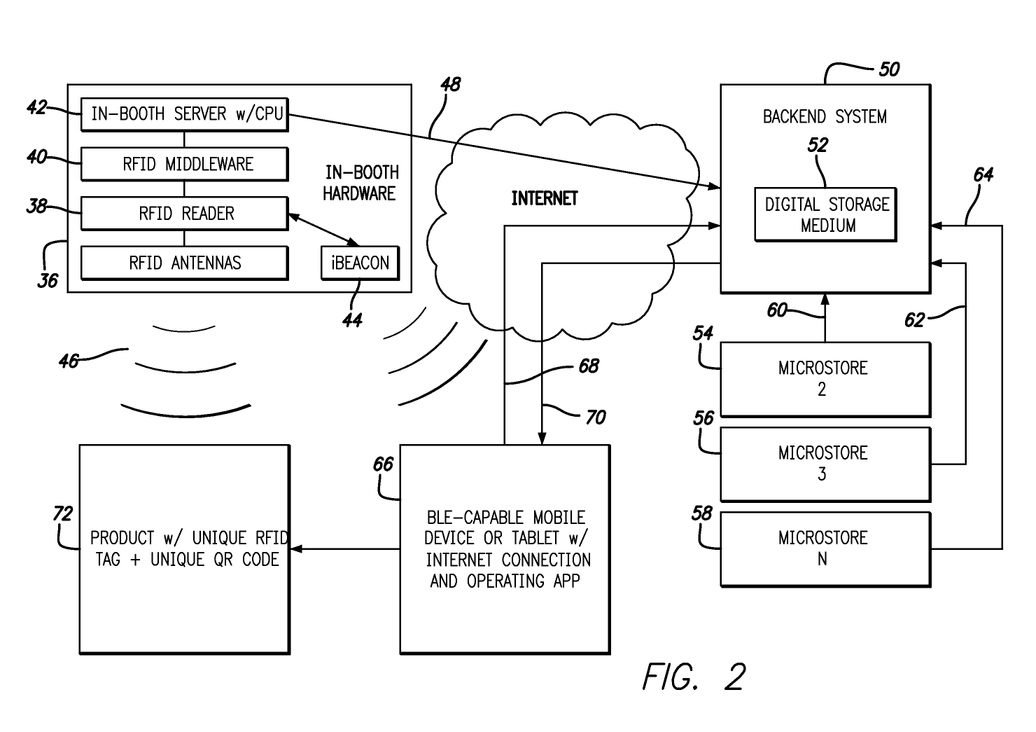

Referring now more particularly to FIG. 2, there is illustrated the system constructed in accordance with the principles of the present invention and contained within the micro store booth as illustrated in FIG. 1. As is therein shown, the hardware which is contained within the micro store booth is illustrated at 36. The micro store booth hardware contains the RFID antennas as shown at 26 and 28 in FIG. 1 and also includes an RFID reader 38 and RFID middleware 40 as well as a server which has a central processing unit 42. The central processing unit (CPU) within the server 42 is programed to activate the RFID antennas to send electro magnetic energy pulses as illustrated generally at 46 to activate the passive RFID tags which are attached to each of the products positioned within the micro store booth stand-alone unit 10. The hardware also preferably includes a Bluetooth low energy (BLE) capable device such as an iBeacon 44 which is utilized to communicate with the BLE capable mobile device of a customer. The iBeacon is a location flag which identifies precisely where the customer is located relative to the micro store booth. For example, if the customer is standing in front of the panel 20, the iBeacon would so indicate and the customer would then receive product information about all the products on panel 20. However, if the customer's mobile device is not BLE capable, the system would still function through the use of the QR code on the product. The customer would simply scan the QR code and this would provide detailed information about the product and would also provide the customer's relative location to the micro store booth system.

As indicated above, when the RFID antennas activate the passive RFID tags, information contained thereon which is unique to each of the products contained within the micro store booth is read by the RFID reader 38. That information is then converted into appropriate digital format to be read by the server. That information is then transmitted as indicated at 48 to the backend system 50 which is remotely located from the micro store booth. The backend system 50 also contains a digital storage medium 52 which receives the product inventory information generated from activating the RFID tags as above described. Product may be purchased by a customer and removed from the micro store booth or new product may be added from time to time. To maintain up-to-date and real time information about the inventory, the CPU is programmed to activate the antennas several times each minute and more particularly once approximately each five seconds. As is illustrated at 54, 56 and 58, there may be additional micro store booths, in this instance indicated as 2, 3 and N, which are situated in various retail establishments and also are wired or wirelessly connected to the backend system 50 as shown by the arrows 60, 62 and 64, respectively. It will thus be understood that a plurality of micro store booths may be disposed and situated within various retail establishments throughout various areas all of which may then be connected to the backend system and will receive the information regarding the inventories contained within each of the micro store booths as illustrated in FIG. 1.

When a customer wishes to access the micro store booth within a particular locality such will preferably be done through the utilization of a Bluetooth low energy capable mobile device or tablet as illustrated at 66. The mobile device will then interact through an internet connection 68 with the information as shown at 70. As is therein indicated, the micro store booth app would be downloaded onto the mobile device and the device would then be activated so as to interact with the products situated within the micro store booth. The BLE iBeacon 44 communicates with the BLE capable mobile device 66 to identify the specific micro store booth that the customer is at as well as the relative location of the customer to the specific micro store booth. This will then allow the product and inventory information specific to that booth to be transmitted to the customer's mobile device. Although it is preferable that BLE capable mobile devices are used, it should be understood that the product and inventory information may also be provided to mobile deices that are not BLE capable. As is shown at 72, the mobile device would scan the unique QR code that is on a particular product and when such is done, the product information contained in the backend system unique to that product would appear on the mobile device held by the customer and the customer may then proceed to purchase the product if such is desired.

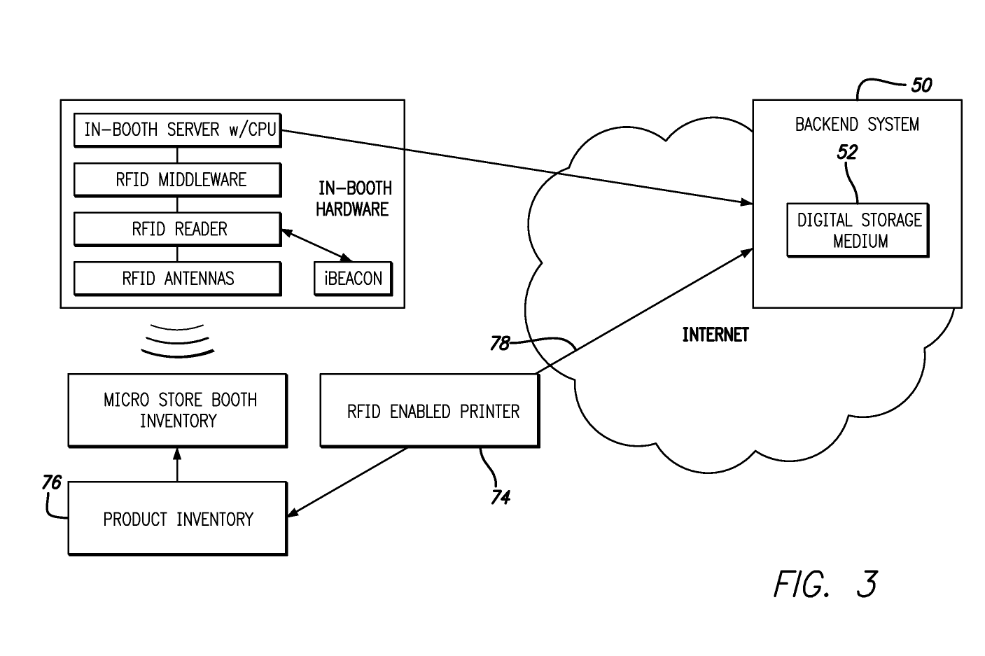

Referring now more specifically to FIG. 3, there is shown in block diagram form the manner in which the products in the micro store booth are properly configured. As is therein illustrated, the backend system would communicate with an RFID enabled printer 74 to print an appropriate RFID tag to reflect the information unique to a product and that tag would then be attached to that particular product as illustrated at 76. As above indicated, in addition, that particular product would have a unique QR code also attached thereto. When the RFID tag is printed, the unique identifier information is submitted to the backend system as illustrated by the lead 78 and would be stored on the digital storage medium 52. The remaining portions of the hardware within the micro store booth and the manner in which it functions is identical to that discussed above with regard to FIG. 2.

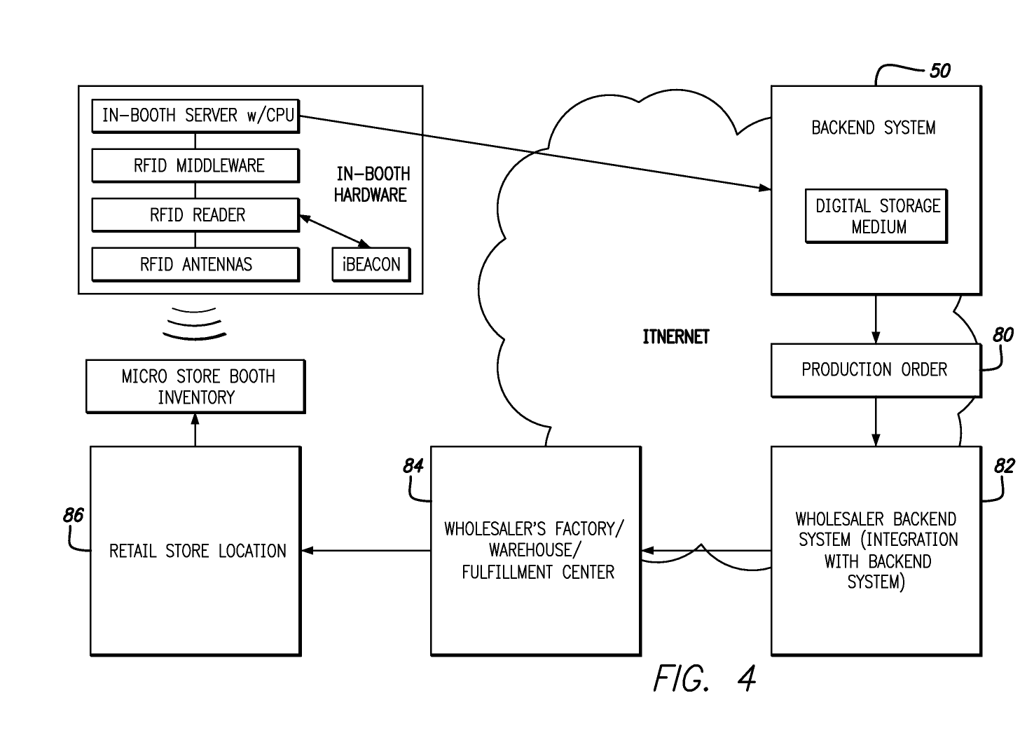

Referring now more particularly to FIG. 4, there is illustrated in block diagram form the manner in which products are replaced in the micro store booth after purchase of products by a consumer. The backend system 50 would become aware of the fact that the inventory of product contained in the micro store booth was depleted by a predetermined amount. When such occurs, a production order 80 would be generated and transmitted to a wholesaler 82 or other source which provides products for the micro store booth. The wholesaler upon receiving the production order would then communicate with the factory as indicated at 84 or the warehouse or other fulfillment center which would generate or have on hand the particular product for which a production order has been placed. When the wholesaler's factory/warehouse/fulfillment center 84 receives this information and then provides the product, that product is forwarded to the retail store location 86 where the micro store booth is located. When such occurs, the product would then be placed in the micro store booth and become part of the inventory. The remainder of the system as illustrated in FIG. 4 would function precisely the same as above discussed with respect to FIGS. 2 and 3.

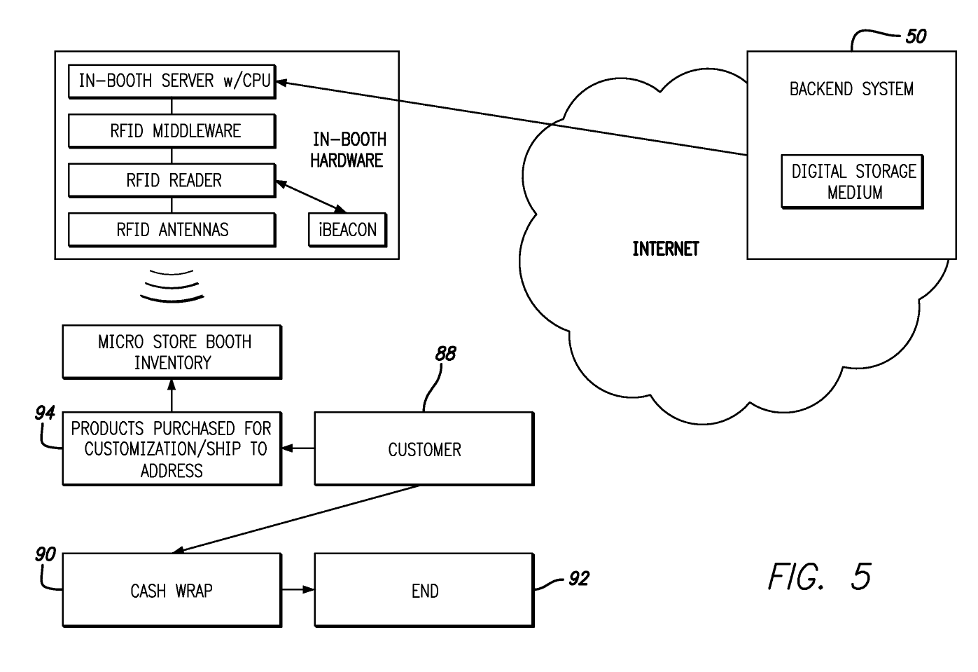

Referring now more specifically to FIG. 5, there is illustrated in block diagram form the manner in which the customer interacts with a micro store booth in order to purchase product or, if desired, to customize the product. As is therein illustrated, the customer 88 generates an account on his or her personal mobile device or on the micro store booth touch screen device 30 as shown in FIG. 1. The customer then uses the mobile device or the touch screen device to scan the unique QR code of the specific item of interest that is located in the micro store booth. When such is done, the customer sees the product's details and chooses either to add the particular product to the customer's cart or to then customize a particular product. If the customer desires to purchase the particular product, then the customer completes the purchase according to the check out provisions provided and the product is then sold as indicated at 90 and the process is ended as shown at 92.

If, however, the customer desires to customize a version of the product before purchase or wishes to have the product shipped to a specific address, the customer may then select the customization as shown at 94. When such is done, the customer will then indicate precisely how the product is to be customized such as a particular inseam dimension, additional color, or the like, and also would provide the shipping address for the product. The product as customized would then be added to the cart and the user completes the purchase according to the particular instructions in the system at which point the process is completed. As above indicated, when the particular product is purchased directly from the micro store booth offerings, that particular RFID tag on the product is flagged as purchased in the backend system 50 and as above indicated when the inventory in the micro store booth reaches a predetermined point, the production order is generated as illustrated in FIG. 4.

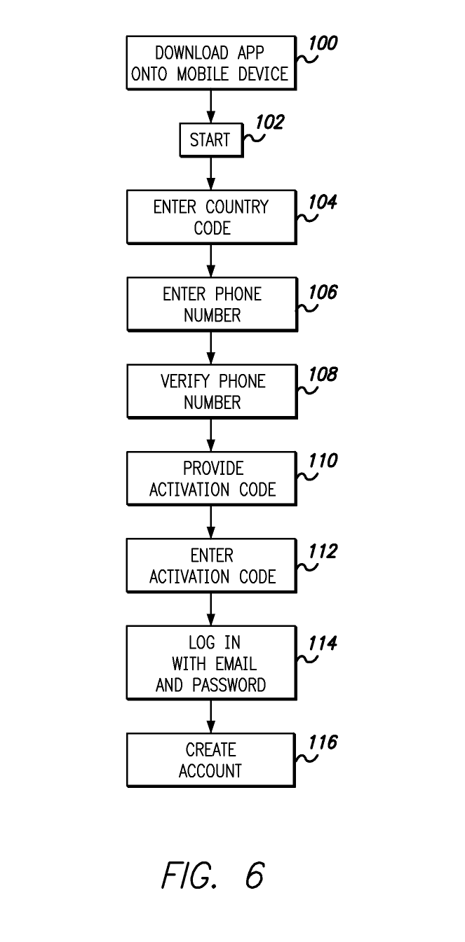

Referring now more particularly to FIG. 6, there is illustrated a flow chart showing the manner in which a customer will initiate contact and interaction with the micro store booth. As shown at 100, the customer would download the micro store booth app onto his or her mobile device and then press the start 102. When such occurs, the customer would be instructed to enter the particular country code of the country in which the customer is located as is shown at 104. The customer would then be instructed to enter a telephone number as shown at 106 and then to verify that telephone number as shown at 108. When such is done, the system would generate and provide to the customer an activation code as shown at 110. The customer would be instructed to enter the activation code as shown at 112. When the activation code is entered, then the customer would be instructed to log in with an e-mail and a password as shown at 114. When the customer does enter the password and the e-mail, then the account is created as is shown at 116.

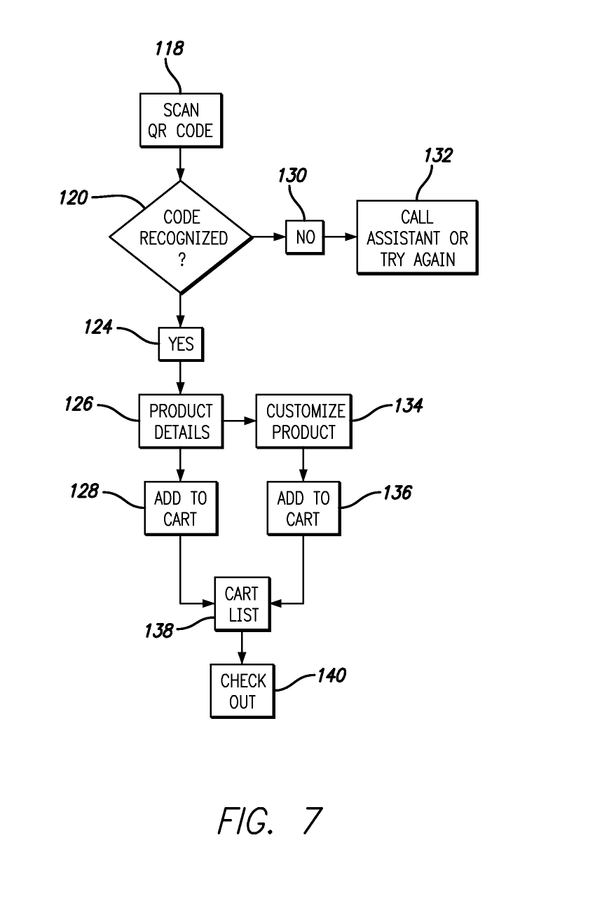

Referring now more particularly to FIG. 7, which provides a flow chart of the manner in which the customer interacts with the micro store booth to purchase the product, and as therein shown, the customer would utilize his or her mobile device to scan the QR code as shown at 118 which is unique to the particular product. The system would then indicate whether or not that code is recognized at 120. If the code is recognized as indicated by the yes at 124, then the product details 126 are provided on the customer's mobile device. The customer, once that is done, would if desired purchase the product and if such is done would then tap onto Add to Cart as shown at 128. If, however, the QR code when scanned is not recognized by the system, the answer would be NO as shown at 130 and the customer would be requested to call an assistant in the retail establishment where the micro store booth is located or alternatively to try to scan the QR code once again as shown at 132. Once the product details are provided as shown at 126, the customer may also decide to customize the product as shown at 134 such as by any particular additional color, inseam dimension or the like. Once that is done, the customized product order would be placed with the wholesaler or factory where the product is generated as above described and that product would then be added to the cart as shown at 136. The customer would then be shown a cart list at 138 and if it is appropriate, the customer would then go to Check Out as shown at 140 and provide the required payment for the products in accordance with the instructions contained in the system.

There has thus been disclosed a system for providing access by a customer to a particular series of products contained within a micro store booth within a retail establishment which can then be either purchased or customized by the customer as may be desired without interacting with the retail store staff and which can also be utilized to provide replenishment of the inventory in the micro store booth as may be desired.

What is claimed is:

1. A system designed for positioning within a retail establishment for providing access by consumers to products having a passive RFID tag and a QR code affixed thereto, said system comprising:
(A) a stand-alone structure having compartments for receiving the products;
(B) an antenna configured to emit an electro magnetic signal to activate the RFID tags;
(C) a server including a central processing unit (CPU) and a memory;
(D) an RFID reader coupled to said server for providing inventory information generated by activation of said RFID tag related to said products to said server;
(E) a Bluetooth low energy capable device coupled to said server;
(F) a remote backend system including a digital storage medium;
(G) means for coupling said server to said remote backend system for transferring said inventory information to said remote digital storage medium; and
(H) a Bluetooth low energy capable mobile device configured to communicate with said remote digital storage medium and said Bluetooth low energy capable device coupled to said server to provide product information to consumers.

2. The system as defined in claim 1 wherein the CPU is programmed to cause the antenna to emit the electro magnetic signal to activate the RFID tag several times each minute to thereby maintain the inventory information current.

3. The system as defined in claim 1 wherein the Bluetooth low energy capable device is iBeacon.

4. The system as defined in claim 1 wherein the stand-alone structure includes a center tower and a plurality of panels connected to and extending from the center tower.

5. The system as defined in claim 4 wherein each of said panels includes a plurality of antennas connected thereto.

6. The system as defined in claim 4 which further includes a touch screen device connected to each of said panels for use by customers who do not have mobile devices.

7. The system as defined in claim 1 which further includes an RFID enabled printer coupled to said backend system.

8. The system as defined in claim 1 which further includes a product provider coupled to said backend system for receiving orders for products when the inventory of said stand-alone structure falls below a predetermined level.

9. The system as defined in claim 1 which further includes a plurality of stand-alone structures including antennas, RFID readers, servers and Bluetooth low energy capable devices wirelessly coupled to said backend system.

10. The system as defined in claim 1 which further includes a mobile application for downloading onto said mobile device to permit a customer to receive product information.

11. A system designed for positioning within a retail establishment for providing access by consumers to products having a passive RFID tag and a QR code affixed thereto, said system comprising:
(A) a stand-alone structure having compartments for receiving the products;
(B) an antenna configured to emit an electro magnetic signal to activate the RFID tags;
(C) a server including a central processing unit (CPU) and a memory;
(D) a RFID reader coupled to said server for providing inventory information generated by activation of said RFID tag related to said products to said server;
(G) a remote backend system including a digital storage medium;
(F) means for coupling said server to said remote backend system for transferring said inventory information to said remote digital storage medium; and
(G) a mobile device configured to communicate with said remote digital storage medium to provide product information to consumers.
